(19) United States
(12) Patent Application Publication
(10) Pub. No.: US 2022/0355967 A1
(43) Pub. Date: Nov. 10, 2022

(54) SYSTEMS AND METHODS FOR SINGLE-USE COMPOSTABLE CONTAINERS

(71) Applicant: Footprint International, LLC, Gilbert, AZ (US)

(72) Inventor: Matthew Warnick, Gilbert, AZ (US)

(21) Appl. No.: 17/741,171

(22) Filed: May 10, 2022

Related U.S. Application Data
(60) Provisional application No. 63/186,303, filed on May 10, 2021.
(60) Provisional application No. 63/186,313, filed on May 10, 2021.
(60) Provisional application No. 63/190,265, filed on Jan. 1, 0001.

(51) Int. Cl. B65D 1/26; B65D 65/46; B65D 1/34; B65D 85/10; A24F 15/01; B65D 51/24; B29C 51/00

(52) U.S. Cl. CPC B65D 1/26; B65D 65/466; B65D 1/34; B65D 85/10; A24F 15/01; B65D 51/245; B29C 51/002; B29K 2201/00

(57) ABSTRACT

A compostable single-use container generally includes a substantially planar lid component and a tray component. The lid component has a top surface and a bottom surface. The tray component has a generally planar top surface adhesively bonded to the bottom surface of the lid component with a sustainable adhesive, and a chamber configured to store an object. The tray component is thermoformed fiber comprising at least one of recycled cardboard, hemp straw, and cannabis straw. The lid portion comprises at least one of a natural-fiber card stock and a compostable sticker.

### CROSS-REFERENCE TO RELATED APPLICATIONS

This application claims priority to U.S. Provisional Patent Application No. 63/186,303, entitled C-POD, filed on May 10, 2021, and U.S. Provisional Patent Application No. 63/186,313, entitled J-POD filed on May 10, 2021; and U.S. Provisional Patent Application No. 63/190,265, entitled FLOWER POD filed on May 10, 2021, the entire contents of which are hereby incorporated by reference.

### TECHNICAL FIELD

The present invention relates, generally, to the manufacture of plastic-free, fiber-based packaging and containers, and more particularly to compostable, child-resistant, single-use containers.

### BACKGROUND

Pollution caused by plastic containers and packaging materials is epidemic, scarring the global landscape and threatening delicate ecosystems and the life forms that inhabit them. In particularly, single-use containers migrate along waterways to the oceans in the form of Styrofoam and expanded polystyrene (EPS) packaging, to-go containers, bottles, thin film bags and photo-degraded plastic pellets, and the like.

Fiber-based packaging products, on the other hand, are biodegradable, compostable and, unlike plastics, do not migrate into the ocean. While it would be desirable to manufacture all packaging materials and containers using such materials, there remain some container categories that still rely on the use of at least some plastic components.

Child-resistant containers, for example, are based on components that interact in such a way that it is intractable for a child to open, thereby protecting the child from accessing the container's contents (e.g., prescription medicine, cannabis cigarettes, and the like). Such child-proof or child-resistant components are often designed with features of the type that traditionally necessitated the use of plastic materials.

Systems and methods are therefore needed that overcome these and other limitations of prior art single-use, child-resistant containers.

### SUMMARY OF THE INVENTION

The present invention relates to generally child-resistant container designs in which the various components, unlike the prior art, are entirely manufactured from fiber-based materials, and are formed to hold such items as cannabis pre-rolled products, THC or CBD cartridge products, cannabis flower products, and/or other similarly shaped objects. In accordance with one embodiment, a compostable single-use container generally includes a substantially planar lid component and a tray component. The lid component has a top surface and a bottom surface. The tray component has a generally planar top surface adhesively bonded to the bottom surface of the lid component with a sustainable adhesive, and a chamber configured to store an object. The tray component is thermoformed fiber comprising at least one of recycled cardboard, hemp straw, and cannabis straw. The lid portion comprises at least one of a natural-fiber card stock and a compostable sticker

### BRIEF DESCRIPTION OF THE DRAWING FIGURES

The present invention will hereinafter be described in conjunction with the appended drawing figures, wherein like numerals denote like elements, and:

FIGS. 1 and 2 are isometric overviews of various components of a compostable single-use container in accordance with one embodiment;

FIGS. 3A-3B illustrates the assembled compostable single-use container corresponding to the components of FIGS. 1 and 2; and

FIG. 4 is an isometric overview of various components of a compostable single-use container in accordance with another embodiment.

### DETAILED DESCRIPTION OF PREFERRED EXEMPLARY EMBODIMENTS

The present invention generally relates to various designs for compostable single-use containers. In particular, the present invention relates to generally child-resistant container designs in which the various components, unlike the prior art, are entirely manufactured from fiber-based materials, and are formed to hold such items as cannabis pre-rolled products, THC or CBD cartridge products, cannabis flower products, and/or other similarly shaped objects. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to fiber-based materials, paper-processing processes, cannabis products, and the like need not be described herein.

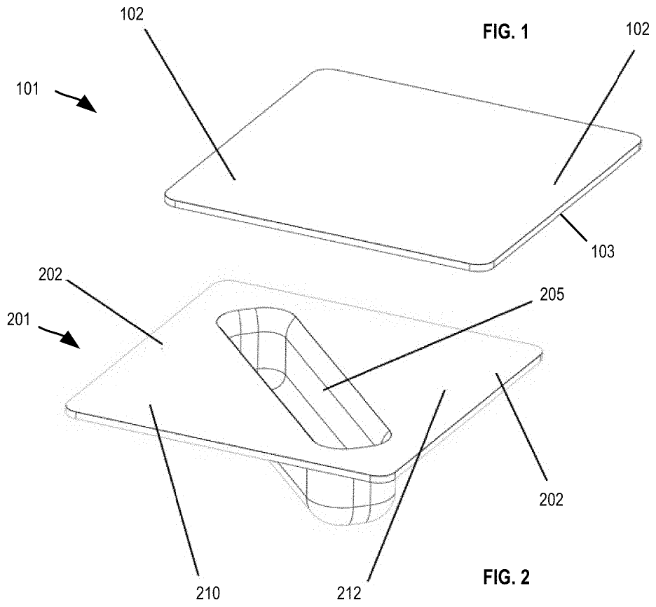

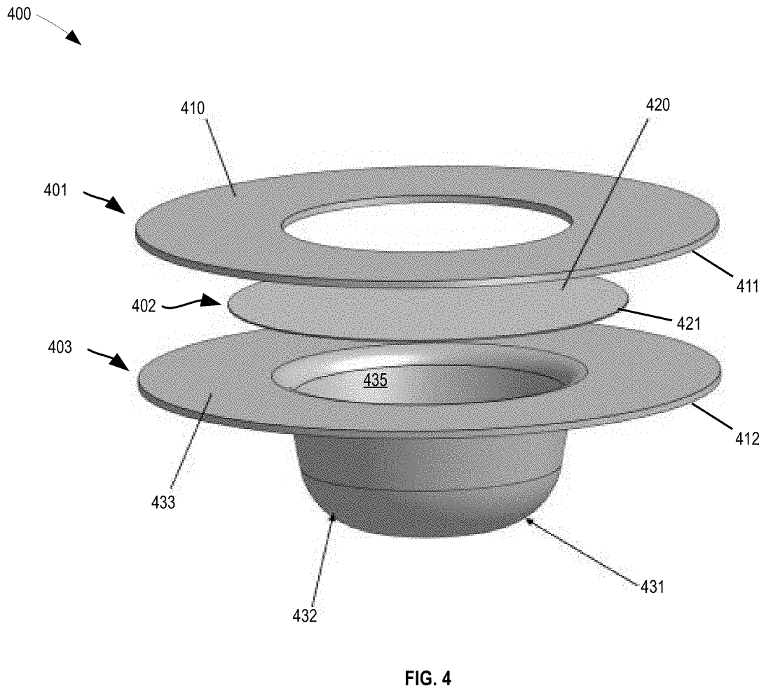

Referring to FIGS. 1 and 2, a compostable, child-resistant single-use container (or simply “container”) generally includes a lid component (or simply “lid”) 101 (FIG. 1) having a top surface 102 and a bottom surface 103. As shown, the lid 101 may be generally planar and have a rectangular shape, although the invention is not so limited (as will be shown below in FIG. 4).

The bottom surface 103 of lid 101 is configured to bond, via a recyclable, compostable, or otherwise sustainable adhesive (as known in the art) to the top surface 202 of a tray component (or simply “tray”) 201 (FIG. 2). Tray 201 further includes a chamber 205, which may be formed as a depression during thermoforming, as described further below.

In the illustrated embodiment, the top surface 202 of tray component 201 includes two generally triangular regions 210 and 212 to provide a large bonding surface on both sides of an elongated chamber 205 oriented at substantially a 45-degree angle relative to the sides of surface 202. Chamber 205 may be configured to fit a cannabis pre-roll object, a THC/CBD cartridge object, or any such object in which child-resistance is preferred, although the invention is not so limited.

Tray 201 preferably comprises a blend of recycled cardboard, hemp fiber, and cannabis fiber, but may be fabricated using any compostable fiber-based material. Lid 101 may be fabricated, for example, using a printed card or sticker having a suitable sustainable adhesive. The thickness of the materials and tensile strength of the adhesive are preferably chosen to create a durable seal that passes applicable child-resistant/child-proof test criteria, as is known in the art (e.g., standards promulgated by the U.S. Consumer Product Safety Commission and/or relevant statutes, such as 16 CFR § 1700.20 — Testing Procedure for Special Packaging).

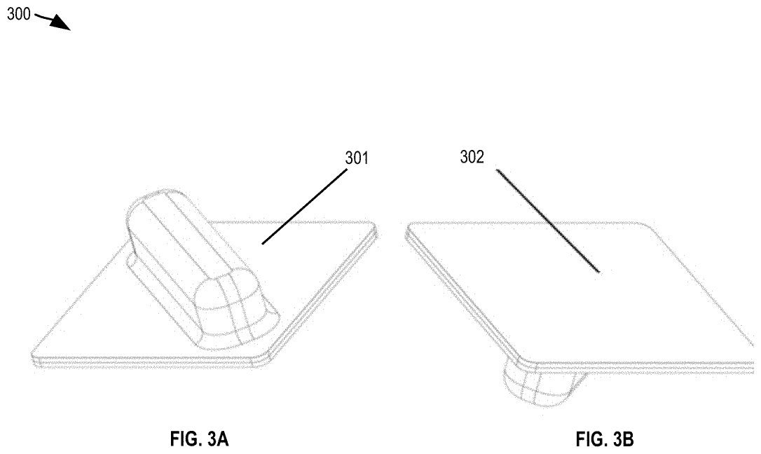

Referring to FIGS. 3A and 3B, the finished, assembled container (having a backside 301 and topside 302) is shown. As will be apparent, the large rectangular topside 302 may be used for displaying product information, branding, and/or the like.

Referring to FIG. 4, an alternate embodiment 400 of the present invention generally includes a generally ring-shaped upper lid 401 (having a bottom surface 411), a clear film component 402, and a tray component 403 having a top surface 433, a bowl region 432 (forming a chamber 435) and a rim 412. The clear film component 402 preferably comprises a biodegradable, compostable clear film and has a diameter greater than the inner diameter of ring-shaped upper lid 401, such that the circumference 421 of component 402 is covered by surface 411 of component 401.

The chamber 435 may be formed to fit any desired object, such as a cannabis flower in the range of 3.5-28.0 grams. Similarly, the materials and methods used to form components 401, 402, and 403 may be equivalent to those used in connection with the embodiments shown in FIGS. 1-3. The material and thickness of the various components shown in the figures may be selected based on, for example, the size and type of object intended to be encapsulated by the chambers 205 and 435. In this regard, it will be appreciated that the embodiments shown in figure are not intended to be limiting with respect to geometrical dimensions, and may not be drawn to scale.

As mentioned briefly above, one of the primary advantages of the present invention is that the containers are biodegradable, rather than plastic. The plastic-free components described herein be manufactured using a variety of fiber-based mixtures of pulp and water, with added chemical components, if desired, to impart performance characteristics tuned to each particular product application. For additional information regarding such fiber-based systems and methods, see, for example U.S. Pat. Nos. 10,815,622, 10,428,467, 9,988,199, and 9,856,608, the entire contents of which are hereby incorporated by reference.

In summary, what has been described are compostable single-use containers of the type including: a substantially planar lid component having a top surface and a bottom surface; a tray component having a generally planar top surface adhesively bonded to the bottom surface of the lid component with a sustainable adhesive, and a chamber configured to store an object; wherein the tray component is thermoformed fiber comprising at least one of recycled cardboard, hemp straw, and cannabis straw; and the lid portion comprises at least one of a natural-fiber card stock and a compostable sticker. In one embodiment, the chamber is formed as a depression relative to the top surface of the tray component. In various embodiments, the chamber is shaped to hold a pre-rolled cannabis cigarette, a THC/CBD cartridge package, or a cannabis flower having a mass in the range of 3.5-28.0 grams. In one embodiment, the container further includes a biodegradable clear film window bonded between the lid component and the tray component, thereby allowing the enclosed objected to be viewed.

In one embodiment, the compostable single-use container is formed from a slurry mixture comprising: i) a moisture barrier component; ii) an oil barrier component that is different from the moisture barrier component; and iii) a strength additive component. In one embodiment, the moisture barrier is in the range of 0.5-10.0% by weight and the oil barrier is in the range of 0.5-10.0% by weight. The moisture barrier contains alkyl ketene dimer (AKD) or similar material.

In general, the base fiber used for any of the above components may include any one or combination of at least the following materials: softwood (SW), bagasse, bamboo, old corrugated containers (OCC), hemp fiber, cannabis fiber, and newsprint (NP). Alternatively, the base fiber may be selected in accordance with the following resources, the entire contents of which are hereby incorporated by this reference: “Lignocellulosic Fibers and Wood Handbook: Renewable Materials for Today's Environment,” edited by Mohamed Naceur Belgacem and Antonio Pizzi (Copyright 2016 by Scrivener Publishing, LLC); “Efficient Use of Flourescent Whitening Agents and Shading Colorants in the Production of White Paper and Board” by Liisa Ohlsson and Robert Federe, Published Oct. 8, 2002 in the African Pulp and Paper Week; Cellulosic Pulps, Fibres and Materials: Cellucon '98 Proceedings, edited by J F Kennedy, G O Phillips, P A Williams, copyright 200 by Woodhead Publishing Ltd.; and U.S. Pat. No. 5,169,497 A entitled “Application of Enzymes and Flocculants for Enhancing the Freeness of Paper Making Pulp” issued Dec. 8, 1992.

For vacuum molded produce containers manufactured using either a wet or dry press, a fiber base of OCC or OCC/DLK and NP may be used, where the OCC/DLK component is between 50%-100%, and preferably about 70% OCC/DLK and 30% NP or VNP, with an added moisture/water repellant in the range of 1%-10% by weight, and preferably about 1.5%-4%, and most preferably about 4%. In a preferred embodiment, the moisture/water barrier may comprise alkyl ketene dimer (AKD) (for example, Hercon 79, Hercon 80) and/or long chain diketenes. In order to yield specific colors for molded pulp products, cationic dye or fiber reactive dye may be added to the pulp. Fiber reactive dyes, such as Procion MX, bond with the fiber at a molecular level, becoming chemically part of the fabric. Also, adding salt, soda ash and/or increase pulp temperature will help the absorbed dye to be furtherly locked in the fabric to prevent color bleeding and enhance the color depth.

To enhance structural rigidity, a starch component may be added to the slurry, for example, liquid starches available commercially as Topcat® L98 cationic additive (or Hercobond 6950 available from Solenis LLC), Hercobond, and Topcat® L95 cationic additive (available from Penford Products Co. of Cedar Rapids, Iowa). Alternatively, the liquid starch can also be combined with low charge liquid cationic starches such as those available as Penbond® cationic additive and PAF 9137 BR cationic additive (also available from Penford Products Co., Cedar Rapids, Iowa).

For dry press processes, Topcat L95 or Hercobond 6950 may be added as a percent by weight in the range of .5%-10%, and preferably about 1%-7%, and particularly for products which need maintain strength in a high moisture environment most preferably about 6.5%; otherwise, most preferably about 1.5-2.0%. For wet press processes, dry strength additives such as Topcat L95 or Hercobond 6950 which are made from modified polyamines that form both hydrogen and ionic bonds with fibers and fines. Dry strength additives help to increase dry strength, as well as drainage and retention, and are also effective in fixing anions, hydrophobes and sizing agents into fiber products. Those additives may be added as a percent by weight in the range of .5%-10%, and preferably about 1%-6%, and most preferably about 3.5%. In addition, both wet and dry processes may benefit from the addition of wet strength additives, for example solutions formulated with polyamide-epichlorohydrin (PAE) resin such as Kymene 920A or 1500 or similar component available from Ashland Specialty Chemical Products. In a preferred embodiment, Kymene 920A or 1500 may be added in a percent by volume range of .5%-10%, and preferably about 1%-4%, and most preferably about 2% or equal amount with dosing of dry strength additives. Kymene 920A or 1500 is of the class of polycationic materials containing an average of two or more amino and/or quaternary ammonium salt groups per molecule. Such amino groups tend to protonate in acidic solutions to produce cationic species. Other examples of polycationic materials include polymers derived from the modification with epichlorohydrin of amino containing polyamides such as those prepared from the condensation adipic acid and dimethylene triamine, available commercially as Hercosett 57 from Hercules and Catalyst 3774 from Ciba-Geigy.

The present inventor has determined that molded fiber containers can be rendered suitable as single use containers by embedding barrier chemistries into the slurry, adding a topical coating to the finished vacuum formed container, or both. In particular, the slurry and/or topical coating chemistry should advantageously accommodate one or more of the following three performance metrics: i) moisture barrier; ii) oil barrier; and iii) water vapor (condensation) barrier to avoid condensate due to placing the hot container on a surface having a lower temperature than the container.

In this context, the extent to which water vapor permeates the container is related to the porosity of the container, which the present invention seeks to reduce. That is, even if the container is effectively impermeable to oil and water, it may nonetheless compromise the user experience if water vapor permeates the container, particularly if the water vapor condenses on a cold surface, leaving behind a moisture ring. The present inventor has further determined that the condensate problem is uniquely pronounced in fiber-based applications because water vapor typically does not permeate a plastic barrier.

Accordingly, for various containers the present invention contemplates a fiber or pulp-based slurry including a water barrier, oil barrier, and water vapor barrier, and an optional retention aid. In an embodiment, a fiber base of softwood (SW)/bagasse at a ratio in the range of about 10%-90%, and preferably about 7:3 may be used. As a moisture barrier, AKD may be used in the range of about .5%-10%, and preferably about 1.5%-4%, and most preferably about 3.5%. As an oil barrier, the grease and oil repellent additives are usually water based emulsions of fluorine containing compositions of fluorocarbon resin or other fluorine-containing polymers such as UNIDYNE TG 8111 or UNIDYNE TG-8731 available from Daikin or World of Chemicals. The oil barrier component of the slurry (or topical coat) may comprise, as a percentage by weight, in the range of .5%-10%, and preferably about 1%-4%, and most preferably about 2.5%. As a retention aid, an organic compound such as Nalco 7527 available from the Nalco Company of Naperville, Ill. May be employed in the range of .1%-1% by volume, and preferably about .3%. Finally, to strengthen the finished product, a dry strength additive such as an inorganic salt (e.g., Hercobond 6950). As mentioned, vapor barrier performance is directly impacted by porosity of the fiber tray. Reducing the porosity of the fiber tray and, hence, improving vapor barrier performance can be achieved using at least two approaches. One is by improving freeness of the tray material by grinding the fibers. The second way is by topical spray coating using, for example, Daikin S2066, which is a water based long chain Fluorine-containing polymer. Spray coating may be implemented using in the range of about 0.1%-3% by weight, and preferably about 0.2%-1.5%, and most preferably about 1%.

A method of forming a compostable single-use container in accordance with various embodiments generally includes: forming a substantially planar lid component having a top surface and a bottom surface; thermoforming, from a pulp-based fiber material, a tray component having a generally planar top surface adhesively bonded to the bottom surface of the lid component with a sustainable adhesive, and a chamber configured to store an object; wherein the tray component comprises at least one of recycled cardboard, hemp straw, and cannabis straw; and the lid portion comprises at least one of a natural-fiber card stock and a compostable sticker.

The system and methods may be described herein in terms of functional and/or logical block components and various processing steps. It should be appreciated that such block components may be realized and implemented by any number of hardware, software, and/or firmware components configured to perform the specified functions.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A compostable single-use container comprising:
a substantially planar lid component having a top surface and a bottom surface;
a tray component having a generally planar top surface adhesively bonded to the bottom surface of the lid component with a sustainable adhesive, and a chamber configured to store an object;
wherein the tray component is thermoformed fiber comprising at least one of recycled cardboard, hemp straw, and cannabis straw; and
the lid portion comprises at least one of a natural-fiber card stock and a compostable sticker.

2. The compostable single-use container of claim 1, wherein the chamber is formed as a depression relative to the top surface of the tray component.

3. The compostable single-use container of claim 1, wherein the chamber is shaped to hold a pre-rolled cannabis cigarette.

4. The compostable single-use container of claim 1, wherein the chamber is shaped to hold a THC/CBD cartridge package.

5. The compostable single-use container of claim 1, wherein the chamber is shaped to hold a cannabis flower having a mass in the range of 3.5-28.0 grams.

6. The compostable single-use container of claim 1, further including a biodegradable clear film window bonded between the lid component and the tray component, thereby allowing the enclosed objected to be viewed.

7. The compostable single-use container of claim 1, wherein the tray component is formed from a slurry mixture comprising: i) a moisture barrier component; ii) an oil barrier component that is different from the moisture barrier component; and iii) a strength additive component.

8. The compostable single-use container of claim 7, wherein the moisture barrier is in the range of 0.5-10.0% by weight and the oil barrier is in the range of 0.5-10.0% by weight.

9. The compostable single-use container of claim 7, wherein the moisture barrier contains alkyl ketene dimer (AKD).

10. A method of forming a compostable single-use container comprising:
forming a substantially planar lid component having a top surface and a bottom surface;
thermoforming, from a pulp-based fiber material, a tray component having a generally planar top surface adhesively bonded to the bottom surface of the lid component with a sustainable adhesive, and a chamber configured to store an object;
wherein the tray component comprises at least one of recycled cardboard, hemp straw, and cannabis straw; and
the lid portion comprises at least one of a natural-fiber card stock and a compostable sticker.

11. The method of claim 10, wherein the chamber is formed as a depression relative to the top surface of the tray component.

12. The method of claim 10, wherein the chamber is shaped to hold a pre-rolled cannabis cigarette.

13. The method of claim 10, wherein the chamber is shaped to hold a THC/CBD cartridge package.

14. The method of claim 10, wherein the chamber is shaped to hold a cannabis flower having a mass in the range of 3.5-28.0 grams.

15. The method of claim 1, further including forming a biodegradable clear film window and bonding it between the lid component and the tray component, thereby allowing the enclosed objected to be viewed.

16. The method of claim 10, wherein the tray component is formed from a slurry mixture comprising: i) a moisture barrier component; ii) an oil barrier component that is different from the moisture barrier component; and iii) a strength additive component.

17. The method of claim 16, wherein the moisture barrier is in the range of 0.5-10.0% by weight and the oil barrier is in the range of 0.5-10.0% by weight.

18. The method of claim 16, wherein the moisture barrier contains alkyl ketene dimer (AKD).
